(19) United States
(12) Patent Application Publication
(10) Pub. No.: US 2005/0216435 A1
(43) Pub. Date: Sep. 29, 2005

(54) Digital camera and method of managing folder of digital camera

(75) Inventor: Jae-myung Lee, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/005,105

(22) Filed: Dec. 6, 2004

(30) Foreign Application Priority Data
Mar. 27, 2004 (KR) 2004-20992

(51) Int. Cl. G06F 3/00

(52) U.S. Cl. 707/1

(57) ABSTRACT

A digital camera for recording image data of a photographed object and reproducing the recorded image data is provided. The digital camera includes: a memory which includes a standard folder in which image data for recording and reproducing the image of the photographed object is stored, and a favorite folder in which image data from the images stored in the standard folder is transferred and stored according to selection of a user; a display unit which outputs the images stored in the folders; a manipulation unit which is used to select an image among image data of the photographed objects; and a control unit which transfers image data of the photographed object between the standard folder and the favorite folder according to selection of the user, and outputs image data stored in the standard folder or the favorite folder to the display unit.

### BACKGROUND OF THE INVENTION

This application claims the priority of Korean Patent Application No. 2004-20992, filed on Mar. 27, 2004, in the Korean Intellectual Property Office, the disclosure of which is incorporated herein in its entirety by reference.

1. Field of the Invention

The present invention relates to a digital camera and a method for managing a folder of a digital camera. More particularly, the invention relates to a digital camera having a favorite folder for faster and easier retrieval and a method for managing folders in a digital camera having a favorite folder.

2. Description of the Related Art

In order to store photographed images, a digital camera generally has a removable memory device, such as a compact flash memory and a memory stick, or an embedded memory device. The storage capacity of removable memory devices has been rapidly increasing because of the trend in digital cameras toward high precision images and the development of circuit integration technologies. Consequently, due to the greatly expanding memory capacity available, a user of a digital camera increasingly tends to keep taken photos in a memory device in the digital camera instead of transferring the photos to a personal computer from the digital camera.

The more photos that are stored in a digital camera, the more difficult it becomes for the user to find a desired photo among the stored photos. Accordingly, in order for a user to quickly find a desired photo, various methods for arranging the list of image data or thumbnail images are used. However, when the number of stored photos is very large due to the greatly expanding memory capacity or resolution changes of the stored images, it is difficult for the user to quickly and easily find a photo desired to be reproduced by only arranging the list or the thumbnail images.

Disclosed in Japanese Patent Laid-Open No. 2003-274341 is a method for a user to easily retrieve an image by using a favorite folder in which is recorded an image obtained by reducing an original image. As disclosed in the publication, the file stored in the favorite folder is a file with a smaller size (for example, a thumbnail file) than the original file. According to the method, even after the original image is deleted, the file stored in the favorite folder is not deleted.

The favorite folder disclosed in the application is a space for storing the reduced image separately from both the original image and the history data related to the image. In terms of quick and easy retrieval of the original image, the method does not provide a great improvement compared to the conventional thumbnail file.

### SUMMARY OF THE INVENTION

The present invention provides for a digital camera and a method of managing folders in which, without the need to transfer images to a personal computer and manage the folders in the personal computer, a favorite folder, capable of storing and reproducing image data having the same format as that of photographed image data, is located in the digital camera and from which a user can quickly and easily retrieve a photo.

According to an aspect of the present invention, there is provided a camera for recording the image data of a photographed object and reproducing the recorded image data, including: a memory which includes a standard folder in which image data for recording and reproducing the image of the photographed object is stored and a favorite folder in which image data selected by a user from the images stored in the standard folder is transferred to and stored; a display unit which outputs the images stored in the folders; a manipulation unit which is used to select an image among the photographed image data; and a control unit which transfers the image data of the photographed object selected by the user between the standard folder and the favorite folder, and outputs the image data stored in the standard folder or the favorite folder to the display unit.

The memory has a standard folder for storing photographed image data and a favorite folder in which image data selected by the user is moved to and stored. The user can selectively reproduce images stored in the standard folder and the favorite folder. By storing images in the favorite folder, quick and easy retrieval and download are enabled for the user.

Image data, currently being displayed on the display unit among image data of photographed objects stored in the standard folder, can be moved by the user from the standard folder to the favorite folder by using a predetermined hotkey or a menu key. For this, the manipulation unit may include a unit which transmits a command to the control unit for moving the image data, currently being displayed on the display unit among other image data of photographed objects stored in the standard folder, from the standard folder to the favorite folder. For this type of functionality a predetermined hotkey or a menu key can be included.

For example, in the playback mode of the digital camera (or in temporary playback mode when a photo is temporarily displayed on an LCD display unit immediately after the user shoots a photo in the record mode), while the user views image data currently displayed on the LCD display unit, if the user pushes the predetermined hotkey or the menu key, the control unit moves the image data currently stored in the standard folder to the favorite folder.

In a specific console input method capable of moving image data to the favorite folder by using a limited number of keys (buttons) located on a compact-type camera, the image data can be moved to the favorite folder immediately after the hotkey is pushed, or the image data can be moved to the favorite folder by other console input methods through manipulation of a menu key, or by combination of a plurality of buttons being pushed together, or by double-clicking one button.

The control unit may move an image that is stored in the standard folder and is being currently displayed on the display unit from the standard folder to the favorite folder, and then output to the display unit the latest image, excluding the moved image, stored in the standard folder. Specifically, if the image data being currently displayed on the LCD display unit is moved from the standard folder to the favorite folder by using a predetermined hotkey or menu key, the LCD display unit will output the next latest image data, excluding the moved image data, to the display unit according to the order of first-in-last-out (FILO). Accordingly, a user can move the images output to the LCD display unit to the favorite folder in the reverse order in which images are photographed and stored.

In another embodiment, the user selects some of the images, among image data of photographed objects stored in the standard folder, by using a predetermined hotkey or menu key, and then, can move the selected image data at once from the standard folder to the favorite folder. For this, the manipulation unit may include: a unit for receiving a selection input from the user for selecting some of the image data stored in the standard folder; and a unit for transmitting a command to the control unit for moving the selected image data to the favorite folder.

The manipulation unit may further include: a unit for transmitting a command to the control unit for outputting the list of image data stored in the standard folder to the display unit; and a unit for receiving a selection input from the user for selecting part of the list of the image data. For example, while viewing the list or thumbnail of image data stored in the standard folder, the user can select image data desired to be moved to the favorite folder, by pushing the menu key. Accordingly, the control unit moves only the selected files from the standard folder to the favorite folder.

Also, in order for the user to conveniently see that the image data is stored in the favorite folder, data capable of displaying a predetermined mark (for example, ‘\mathring{ƒ}’ mark) on part of an image can be added to the image data stored in the favorite folder. Thus, when the image stored in the favorite folder is output, the display unit can output the mark together with the image.

While viewing images stored in the favorite folder through the LCD display unit, the user can move image data being currently displayed back to the standard folder, for example, by pushing a predetermined hotkey or menu key. The control unit may move the image data being currently displayed on the display unit among image data of the photographed object stored in the favorite folder from the favorite folder to the standard folder, and then output the latest image data, excluding the moved image data, among image data of the photographed object stored in the favorite folder, to the display unit. That is, if according to the order of FILO, image data being currently displayed on the LCD display unit is moved from the favorite folder to the standard folder through the predetermined hotkey or menu key, the LCD display unit outputs the next latest image data, excluding the moved image data, to the display unit. Accordingly, the user can move the images output to the LCD display unit to the standard folder in order of the latest images stored in the favorite folder (that is, in the reverse of the order in which images are moved from the standard folder and stored).

Preferably, display data to inform the user that the image data is stored in the favorite folder is added to image data stored in the favorite folder. For example, in order for the user to conveniently see that the image data is stored in the favorite folder, data capable of displaying a predetermined mark (for example, ‘\mathring{ƒ}’ mark) on part of an image can be added to the image data stored in the favorite folder.

In another embodiment, the user selects some of image data among image data of photographed objects stored in the favorite folder by using the predetermined hotkey or menu key, and then, can move the selected image data at once from the favorite folder to the standard folder. For this, the manipulation unit may include: a unit for receiving a selection input from the user for selecting some images of photographed objects stored in the favorite folder; and a unit for transmitting a command to the control unit for moving the selected image data to the standard folder. At this time, the manipulation unit may also include: a unit for transmitting a command to the control unit for outputting the list or thumbnail of image data stored in the favorite folder to the display unit; and a unit for receiving a selection input from the user for selecting part of the list or thumbnail of the image data. For example, while viewing the list or thumbnail of image data stored in the favorite folder, the user can select image data desired to be moved to the standard folder, by pushing the menu key. Accordingly, the control unit moves only the selected files from the favorite folder to the standard folder.

When data capable of displaying a predetermined mark (for example, ‘\mathring{ƒ}’ mark) on part of an image is added to the image data stored in the favorite folder, the control unit can delete the predetermined mark (for example, ‘\mathring{ƒ}’ mark) while moving the selected files to the standard folder.

According to another aspect of the present invention, there is provided a method for managing folders of a digital camera for recording image data of a photographed object and reproducing the recorded image data, the method including: generating a favorite folder capable of storing a file with the same format as that of a file to be stored in a standard folder; generating image data by photographing an object and storing the image data in the standard folder; and moving the generated image data, selected by a user, between the standard folder and the favorite folder.

The method may further include: displaying the image data of the photographed object stored in the standard folder, wherein moving the generated image includes moving image data being currently displayed from the standard folder to the favorite folder. Accordingly, while viewing image data stored in the standard folder through the LCD display unit, the user can move the image data to the favorite folder by using a predetermined hotkey or menu key. After the image data being currently displayed among the image data of photographed objects stored in the standard folder is moved from the standard folder to the favorite folder, the latest image data, excluding the moved image data, among the image data of photographed objects stored in the standard folder may be output to the display unit. Specifically, image data being currently displayed on the LCD display unit is moved from the standard folder to the favorite folder by using the predetermined hotkey or the menu key. The LCD display unit then outputs the next latest image data, excluding the moved image data, to the display unit according to the order of first-in-last-out (FILO). Accordingly, the user can move the output images to the LCD display unit to the favorite folder in order of the latest photographed images (that is, in the reverse of the order in which images are photographed and stored).

When the user selects some of the image data among the image data of photographed objects stored in the standard folder by using the predetermined hotkey or menu key, the user can then move the selected image data at once from the standard folder to the favorite folder. Moving the image data may include: receiving a selection input from the user for selecting some of image data of the photographed objects stored in the standard folder; and moving the selected image data to the favorite folder. Also, displaying the image data may include: outputting the list or thumbnail of the image data stored in the standard folder to the display unit, so that a user can select part of the list or thumbnail of the image data to be moved.

In addition, while viewing images stored in the favorite folder through the LCD display unit, the user can move image data being currently displayed back to the standard folder, for example, by pushing a predetermined hotkey or menu key. That is, the folder management method may further include: displaying the image data stored in the favorite folder, wherein moving the image data may include: moving image data being currently displayed from the favorite folder to the standard folder. After the image data being currently displayed, among the image data of photographed objects stored in the favorite folder is moved from the favorite folder to the standard folder, the latest image data, excluding the moved image data, among the image data of the photographed objects stored in the favorite folder may be output to the display unit. That is, if according to the order of FILO, the image data being currently displayed on the LCD display unit is moved from the favorite folder to the standard folder through the predetermined hotkey or menu key, the LCD display unit will output the next latest image data, excluding the moved image data, to the display unit. Accordingly, the user can move the images output to the LCD display unit to the standard folder in the order of the latest images stored in the favorite folder (that is, in the reverse of the order in which images are moved from the standard folder and stored).

The user selects some of the image data, among image data of the photographed objects stored in the favorite folder, by using the predetermined hotkey or menu key, and then, can move the selected image data at once from the favorite folder to the standard folder. That is, in the folder management method, moving the image data may include: receiving a selection input from the user for selecting some of the image data of the photographed objects stored in the favorite folder; and moving the selected image data to the favorite folder. Displaying the image data may include: outputting the list or thumbnail of the image data stored in the favorite folder to the display unit, wherein receiving the selection input from the user for moving the image data, part of the list or thumbnail of the image data is selected by the user. Accordingly, the control unit of the digital camera moves only the selected files from the favorite folder to the standard folder.

In order for the user to conveniently see that the image data is stored in the favorite folder, data capable of displaying a predetermined mark (for example, ‘\mathring{ƒ}’ mark) on part of an image may be added to the image data stored in the favorite folder. When image data stored in the favorite folder is moved to the standard folder, the predetermined mark (for example, ‘\mathring{ƒ}’ mark) may be deleted from the image data.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an internal connection structure of major modules of a camera;

FIG. 2 is a diagram showing the basic structure of a standard folder and a favorite folder in a memory card;

FIG. 3 is a schematic diagram of the back surface of a digital camera;

FIGS. 4A through 4C are conceptual diagrams explaining an operation to transfer a file from a standard folder to a favorite folder when a hotkey in a digital camera according to the present invention is pushed;

FIG. 5A is a diagram showing an embodiment in which an image to be transferred from a standard folder to a favorite folder can be selected by using a hotkey or a menu key with reference to the list of image data;

FIG. 5B is a diagram showing an embodiment in which an image to be transferred from a standard folder to a favorite folder can be selected by using a hotkey or a menu key with reference to the thumbnail of image data;

FIGS. 6A and 6B are conceptual diagrams explaining an operation to transfer a file from a favorite folder to a standard folder when a hotkey in a digital camera according to the present invention is pushed;

FIG. 7A is a diagram showing an embodiment in which an image to be transferred from a favorite folder to a standard folder can be selected by using a hotkey or a menu key with reference to the list of image data;

FIG. 7B is a diagram showing an embodiment in which an image to be transferred from a favorite folder to a standard folder can be selected by using a hotkey or a menu key with reference to the thumbnail of image data;

FIG. 8 is a flowchart of an overall embodiment of a folder management method of a digital camera according to the present invention;

FIG. 9 is a flowchart of an embodiment to transfer a file of a standard folder displayed on a display unit to a favorite folder, in a folder management method of a digital camera according to the present invention;

FIG. 10 is a flowchart of an embodiment to transfer the list or thumbnail of files of a standard folder displayed on a display unit to a favorite folder, in a folder management method of a digital camera according to the present invention;

FIG. 11 is a flowchart of an embodiment to transfer a file of a favorite folder displayed on a display unit to a standard folder, in a folder management method of a digital camera according to the present invention; and

FIG. 12 is a flowchart of an embodiment to transfer the list or thumbnail of files of a favorite folder displayed on a display unit to a standard folder, in a folder management method of a digital camera according to the present invention.

### DETAILED DESCRIPTION OF THE INVENTION

The present invention will now be described more fully with reference to the accompanying drawings, in which exemplary embodiments of the invention are shown.

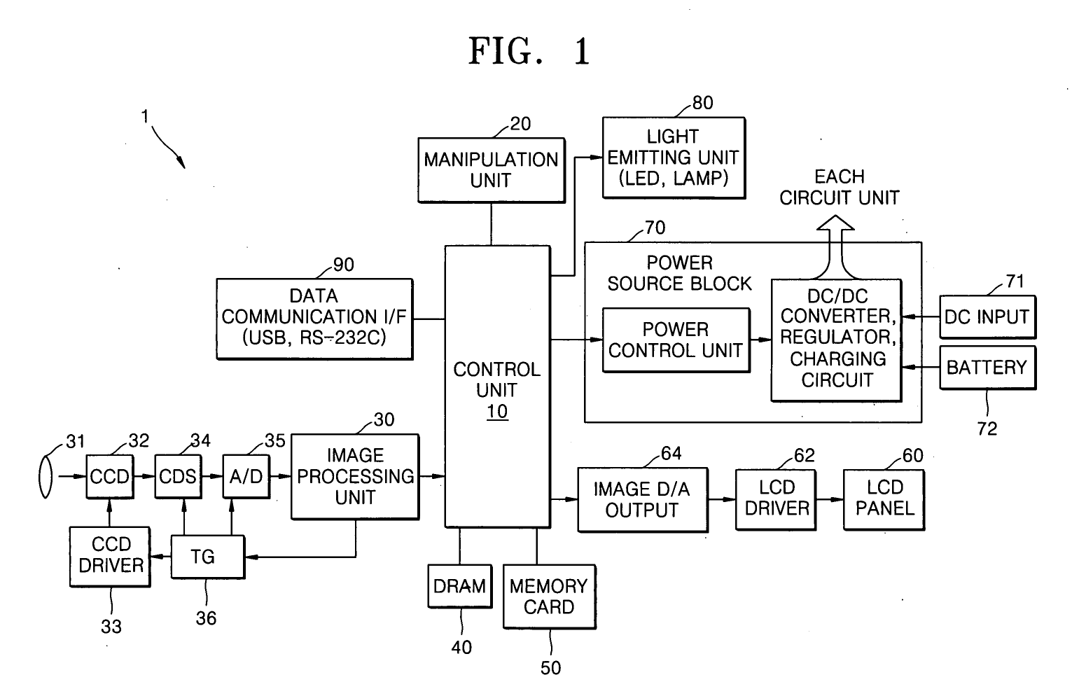

Referring to FIG. 1, the control unit 10 is made up of a microprocessor and a system controller. The control unit generally controls the camera according to a predetermined program, and controls the operation of each circuit in the camera 1 based on a command signal from a manipulation unit 20. Also, the control unit 10 has an internal memory in which control programs or various data are temporarily stored.

The manipulation unit 20 is a unit for a user to input various commands to the camera 1. The manipulation unit 20 includes: a mode selection switch for selecting an operation mode of the camera 1; a menu key for commanding the display of a menu screen; keys for manipulating the menu items and the cursor movements, the movement of reproduction images, and a command for return; a cancel key for deleting a desired object such as a selected item, or cancelling a command; and other key switches, power switches, zoom switches, and release switches.

In the power block 70 of the camera, power is supplied by an external power source connected to a DC input terminal or a battery. Secondary cells can be used as the battery. Power provided from the DC input terminal 71 or battery 72 is converted by the DC/DC converter and regulator into the voltage required by the power circuit. The power is then provided to each circuit unit inside the camera 1. The power block 70 may also have a voltage detection circuit to detect any remaining power in the battery, and a charging circuit to charge the battery. The control unit 10 controls the operation of the power block 70, such as the charging operation, by sending a command to the power control unit, and at the same time, can obtain various information required for control, such as the type of power used in the power block 70 or battery power.

The control unit 10 determines the state of the camera 1 based on a signal received from the power block 70 and the internal circuits, and an input signal from the manipulation unit 20. The control unit 10 controls the light emitting unit 80 according to the state of the camera as determined by the signals received.

Also, the camera 1 has a data communication interface 90 for data transmission and reception with a personal computer and external devices. This interface may employ, for example, a USB, an IEEE1394, or a Bluetooth device.

To shoot a picture with the camera, light first passes through the camera lens 31 and is incident on a charge coupled device (CCD) 32. On the light reception surface of the CCD 32, a plurality of photo sensors are arranged two-dimensionally and have a predetermined color filter array structure other than a Bayer-type array. In place of the CCD 32, devices other than a CMOS image sensor can be used. The optical image of an object formed on the light reception surface of the CCD 32 through the shooting lens 31 is converted into a signal charge according to the amount of light incident on each photo sensor. The signal charge accumulated in each photo sensor is read into a shift register by a lead gate pulse added from a CCD driver 33, and is then sequentially read as a voltage signal by a register transmission pulse. The CCD 32 has an electronic shutter function which controls the charge accumulation time (shutter speed) of each photo sensor by the timing of the shutter gate pulse.

A signal output from the CCD 32 is transmitted to an analog processing unit 34. After performing correlation double sampling (CDS), color separation, gain adjustment, and so on, the signal is converted into a digital signal by an A/D converter 35 and transmitted to an image processing unit 30. According to commands from the microprocessor, a timing generator (TG) 36 transmits a timing signal for synchronization driving to the CCD driver 33, the analog processing unit 34, and the A/D converter 35. Synchronization of each circuit is performed by this timing signal.

The image processing unit 30 is an image signal processing unit that includes a luminance and chrominance signal generation circuit, a gamma correction circuit, a contour correction circuit, and a white balance correction circuit. The image processing unit 30 processes the image signal according to a command provided by the system controller. Image data input to the image processing unit 30 is converted into a luminance signal (Y signal) and a chrominance signal (Cr and Cb signals). At the same time predetermined processing, such as gamma correction, is performed and the data is stored in a DRAM 40.

A photographed image is output on the LCD panel 60. To output this photographed image, image data from the DRAM 40 is read and transmitted to the control unit 10 through a bus. Data transmission from and to the DRAM 40 is controlled by a memory controller in the control unit 10.

The image data transmitted from the DRAM 40 is converted into a signal of a predetermined type for display (for example, an NTSC color composite video signal) and at the same time is converted into an analog signal by the D/A converter 64. The signal for display is transmitted to an LCD driver 62, and after required signal conversion, is output to the LCD panel such that the image contents are displayed on the LCD panel. The display unit mounted on the camera 1 is not limited to the LCD panel, and an organic EL and other display apparatuses capable of color display can be applied.

The signal for display converted and generated based on the image data is output to a video output terminal (VIDEO OUTPUT) through a video amplifier. By connecting an external image display apparatus, such as a television monitor apparatus, to the video output terminal, the external output of an image signal is enabled.

The operation of a release switch of the manipulation unit 20 will now be explained. If the release switch is pushed in record mode, an auto focus function and a shooting start function are performed. The release switch is a two-stepped switch, including a first switch (S1) which is triggered when the release switch is half pushed, and a second switch (S2) which is triggered when the release switch is fully pushed. If the control unit 10 detects that the release switch is half pushed, the control unit 10 controls the auto focus and the auto exposure, whereas if it detects that the release switch is fully pushed, it begins CCD exposure and signal reading control in order to obtain an image for recording.

The image processing unit 30 has an automatic calculation unit performing calculations required for auto focus and auto exposure. The image processing unit 30 performs a focus evaluation value calculation or auto focus calculation based on the input image signal, and then provides the resulting calculation to the control unit 10.

The control unit 10 controls driving units that drive a variety of motors of a finder barrel unit, based on the calculation received from the auto calculation unit, such that the focus adjustment lens of the optical shooting system is moved to a focal position and, at the same time, the value of the aperture is set to an appropriate one and the mechanical shutter and electric charge accumulation time (shutter speed) of the CCD are controlled. Also, the system controller may control an external light emitting unit (strobe) when necessary according to a command from the microprocessor. The image data obtained when the release switch is fully pushed (S2=ON) is processed for luminance and chrominance signals, is compressed when necessary, and then is stored in the DRAM 40. For compression of data, MPEG and other methods including JPEG method can be used.

The playback mode of the digital camera 1 will now be explained. In the playback mode, the latest file recorded in the memory card 50 is read through the control unit 10. The file that is the object of reproduction is converted into a signal for display, and is output to the LCD panel through the LCD controller. When a television monitor apparatus or another external display apparatus is connected to the video output terminal, the reproduced image is displayed on the external display apparatus. During reproduction, by manipulating an arrow key, the file that is the object of reproduction can be changed.

In the digital camera 1 according to the present invention, in addition to a standard folder in which the image data of a photographed object is stored, the memory card 50 also has a favorite folder. Image data stored in the standard folder can be selected by the user, moved to the favorite folder, and stored there. The favorite folder in the memory card 50 is generated by the control unit 10.

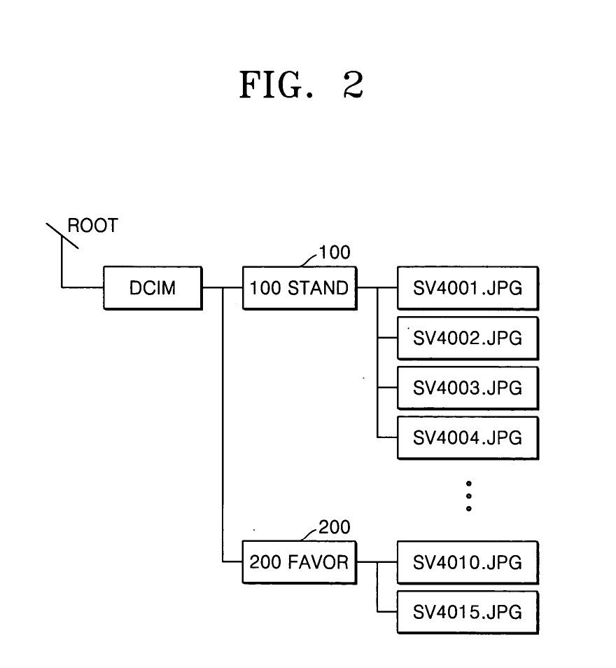

FIG. 2 is a diagram showing the basic structure of a standard folder and a favorite folder in a memory card. In the digital camera 1 according to the present invention, the folder structure for digital camera files (DCF) has a basic folder (DCIM) and a folder 100 in which ordinary files are stored (hereinafter referred to as a ‘standard folder’), and further has a favorite folder 200 to which image data stored in the standard folder can be moved to and stored according to a selection of the user. In the present invention, the display unit 60 outputs images stored in the standard folder 100 while in ordinary playback mode. The display unit 60 can also output an image stored in the favorite folder 200. To select an image, the manipulation unit 20 includes a hotkey, or a menu key, and an arrow key. The control unit 10 moves the image data of the photographed object between the standard folder 100 and the favorite folder 200 based on the selection of the user, and outputs image data stored in the standard folder 100 or in the favorite folder 200.

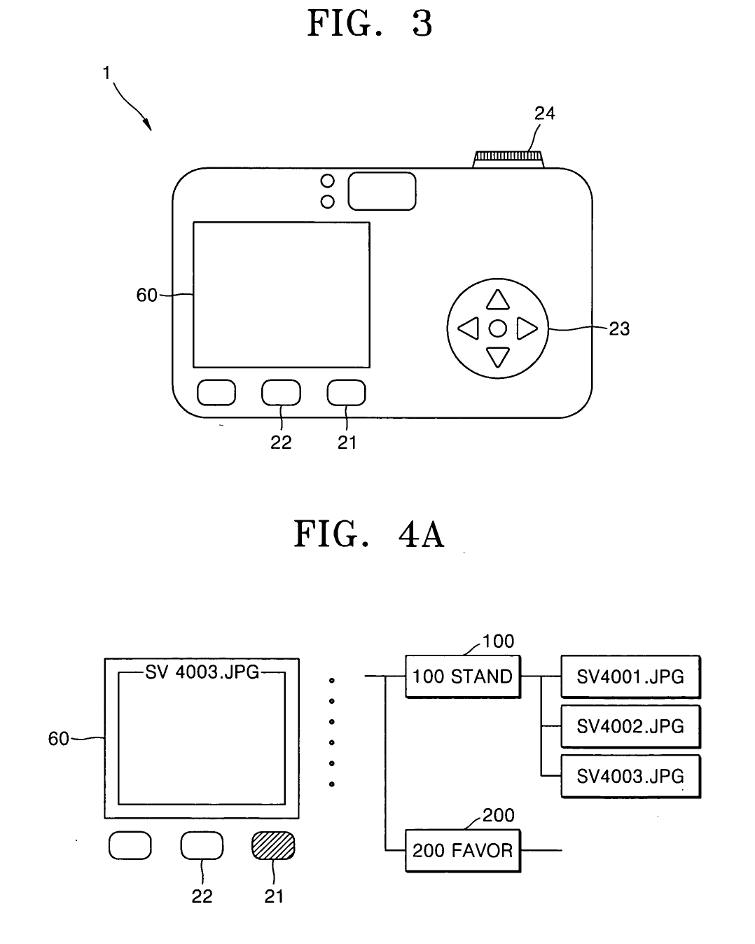

FIG. 3 is a schematic diagram of the back surface of a digital camera. A first hotkey 21, a second hotkey 22, an arrow key 23, and a release switch 24 of the manipulation unit are shown respectively. Generally, the display unit 60 is an LCD display window on the back surface of a digital camera. In the present invention, by using the first hotkey 21, the second hotkey 22, and the arrow key 23, the user can search the standard folder 100 and the favorite folder 200 and move a currently displayed file or a plurality of selected files between the standard folder 100 and the favorite folder 200.

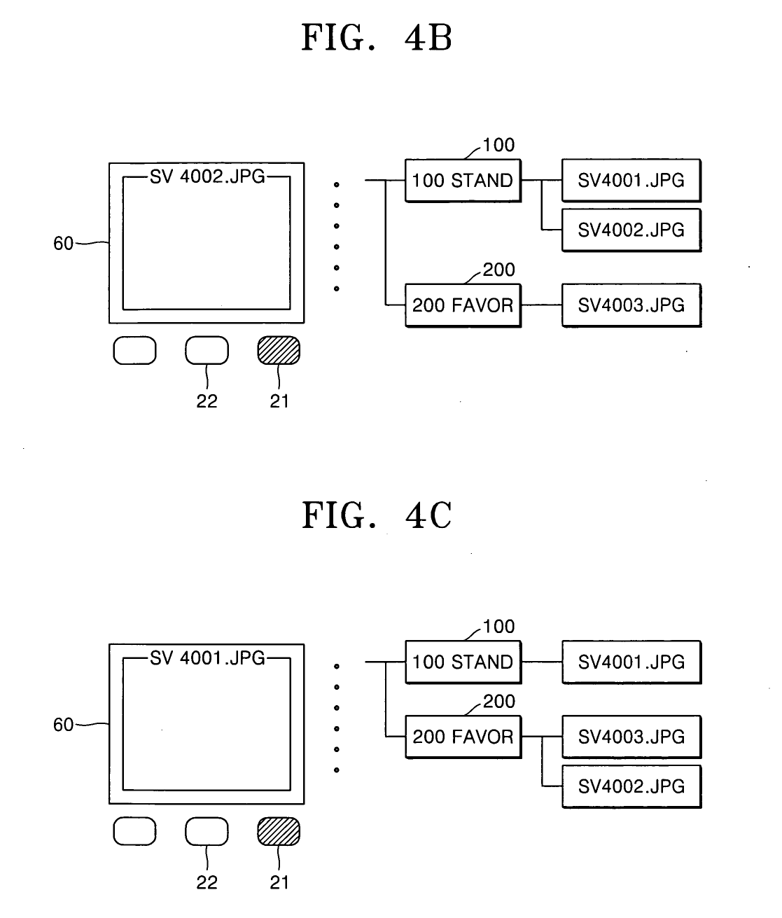

FIGS. 4A through 4C are conceptual diagrams explaining the operation to transfer a file from a standard folder to a favorite folder when the first hotkey 21 in a digital camera according to the present invention is pushed.

While in the record mode of the digital camera 1, when the user shoots a photo of an object, the photo just taken is shown temporarily (for example, for 3˜5 seconds). Image data SV4003.JPG of the photo is stored in the standard folder 100 immediately after shooting the photo. In the folder structure in the memory card 50, the new image data SV4003.JPG is added to image data SV4001.JPG, and SV4002.JPG that are already stored. While in the record mode of the digital camera 1, when the user shoots a photo of an object and the photo just taken is displayed on the display unit 60 temporarily (for example, for 3˜5 seconds), if the user pushes the first hotkey 21, the control unit 10 moves the image data being displayed on the display unit 60 from the standard folder 100 to the favorite folder 200.

Also, as shown in FIG. 4A, in the playback mode of the digital camera 1, a last photo taken is displayed on the display unit 60. In the folder structure in the memory card 50, image data SV4001.JPG, SV4002.JPG and SV4003.JPG are stored. When the user views images in the playback mode, if the user pushes the first hotkey 21, the control unit 10 moves the data of an image being displayed on the display unit 60 from the standard folder 100 to the favorite folder 200. FIG. 4B shows that image data SV4003.JPG is moved to the favorite folder 200 when the first hotkey 21 is pushed in FIG. 4A. In the actual memory structure, by deleting the start address of the storage location of SV4003.JPG in the file allocation information of the standard folder 100 and adding it to the file allocation information of the favorite folder 200, the movement of the file is implemented. In the playback mode, if image data SV4003.JPG is moved to the favorite folder 200, the next latest image SV4002.JPG in the standard folder 100 is displayed on the display unit 60. In this state, if the user pushes the first hotkey 21 again, the control unit will move SV4002.JPG from the standard folder 100 to the favorite folder 200 as shown in FIG. 4C. In the playback mode, after image data SV4002.JPG is moved to the favorite folder 200, SV4001.JPG, the next latest image in the standard folder 100 is displayed on the display unit 60.

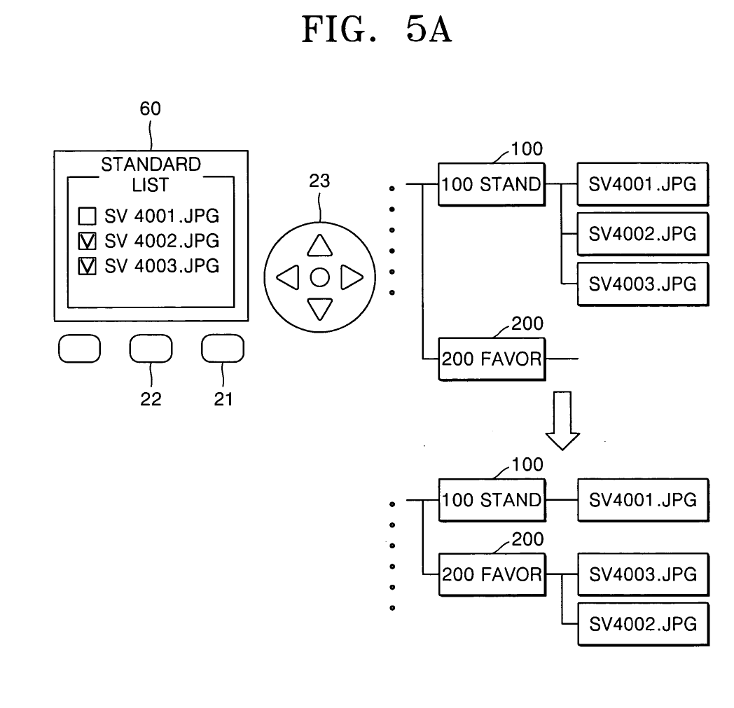

When the user commands, through the manipulation unit 60, the list or thumbnail of image data stored in the standard folder 100 to be displayed on the display unit 60, the display command is transmitted to the control unit 10 from the manipulation unit 60. FIGS. 5A and 5B are diagrams showing embodiments in which the user can select an image(s) from either the list of image data or the thumbnail of image data by referring to the list or thumbnail displayed on the display unit 60 and using the first hotkey 21 and the arrow key 23.

Referring to FIG. 5A, while the user views a list of the standard folder 100, if the user checks image data SV4002.JPG and SV4003.JPG through the manipulation unit 20, image data SV4002.JPG and SV4003.JPG in the standard folder 100 are selected. Then, if the user sends a movement command through the manipulation unit 20, image data SV4002.JPG and SV4003.JPG are moved from the standard folder 100 to the favorite folder 200. The embodiment shown in FIG. 5B is the same as the embodiment in FIG. 5A except that in FIG. 5B the image data is displayed as thumbnails instead of a list and the user can select and send a movement command using the thumbnails.

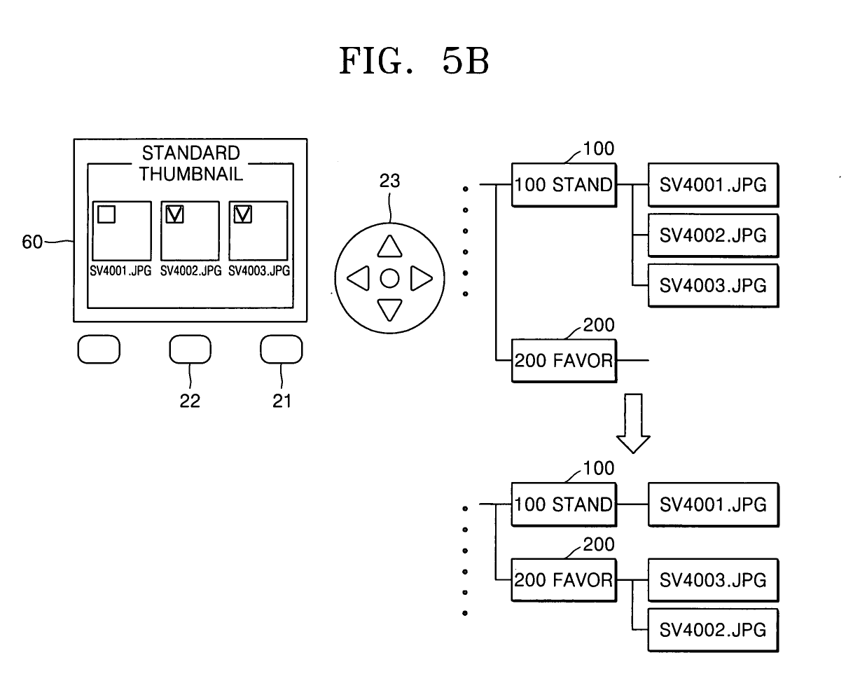

FIGS. 6A and 6B are conceptual diagrams explaining an operation to transfer a file from a favorite folder to a standard folder when the second hotkey 22 in a digital camera according to the present invention is pushed.

FIG. 6A shows the favorite folder which the user views in the playback mode of the digital camera 1. On the display unit 60, the last photo stored in the favorite folder 200 is displayed. In the folder structure in the memory card 50, image data SV4001.JPG is stored in the standard folder 100 and image data SV4002.JPG and SV4003.JPG are stored in the favorite folder 200. While the user views images in the playback mode, if the user pushes the second hotkey 22, the control unit 10 moves the data of the image being displayed on the display unit 60 from the favorite folder 200 to the standard folder 100. FIG. 6B shows that image data SV4002.JPG is moved to the standard folder 100 when the second hotkey 22 is pushed in FIG. 6A. In the actual memory structure, by deleting the start address of the storage location of SV4002.JPG in the file allocation information of the favorite folder 200 and adding it to the file allocation information of the standard folder 100, the movement of the file can be implemented. In the playback mode, if image data SV4002.JPG is moved to the standard folder 100, SV4003.JPG that is the next latest image in the favorite folder 200 is displayed on the display unit 60.

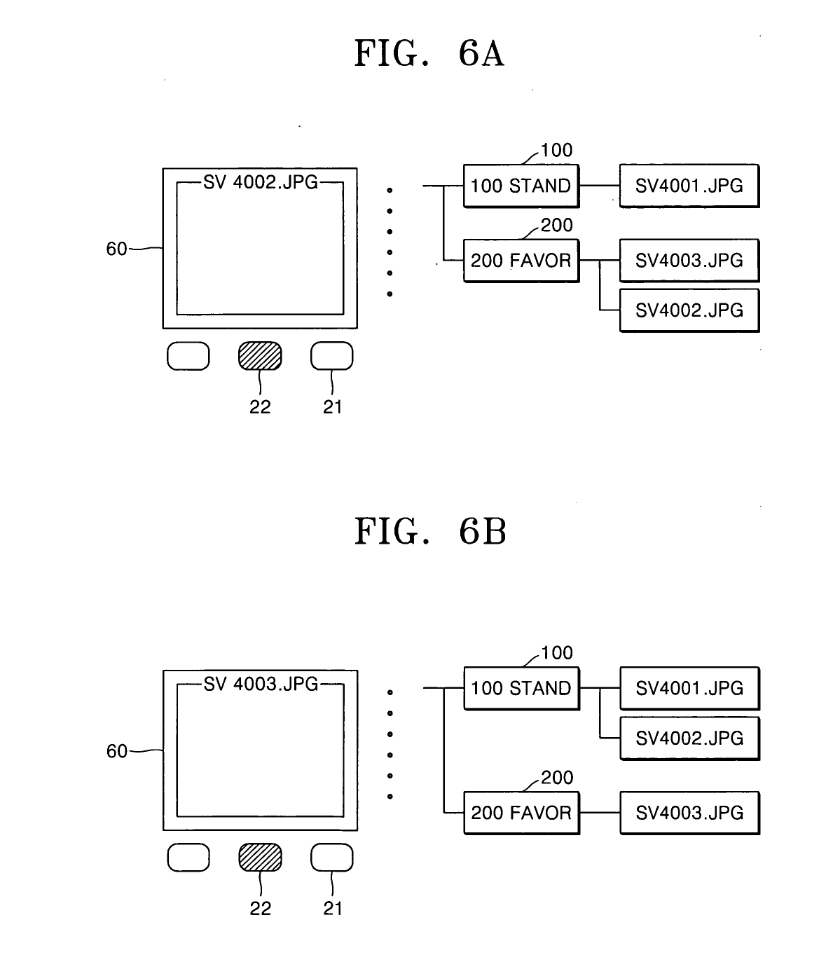

When the user commands through the manipulation unit 60 that the list or thumbnail of image data stored in the favorite folder 200 be displayed on the display unit 60, the display command is transmitted to the control unit 10 from the manipulation unit 60. FIGS. 7A and 7B are diagrams showing embodiments in which the user by referring to the list or thumbnail displayed on the display unit 60 can select any of the images on the list or thumbnail of image data by using the second hotkey 22 and the arrow key 23.

Referring to FIG. 7A, while the user views the list of the favorite folder 200, if the user through the manipulation unit 20 checks image data SV4001.JPG and SV4002.JPG, image data SV4001.JPG and SV4002.JPG in the favorite folder 200 are selected. Then, if the user sends a movement command through the manipulation unit 20, image data SV4001.JPG and SV4002.JPG are moved from the favorite folder 200 to the standard folder 100. The embodiment shown in FIG. 7B is the same as the embodiment in FIG. 7A except that in FIG. 7B the image data is displayed as thumbnails instead of a list and the user can select and send a movement command using the thumbnails.

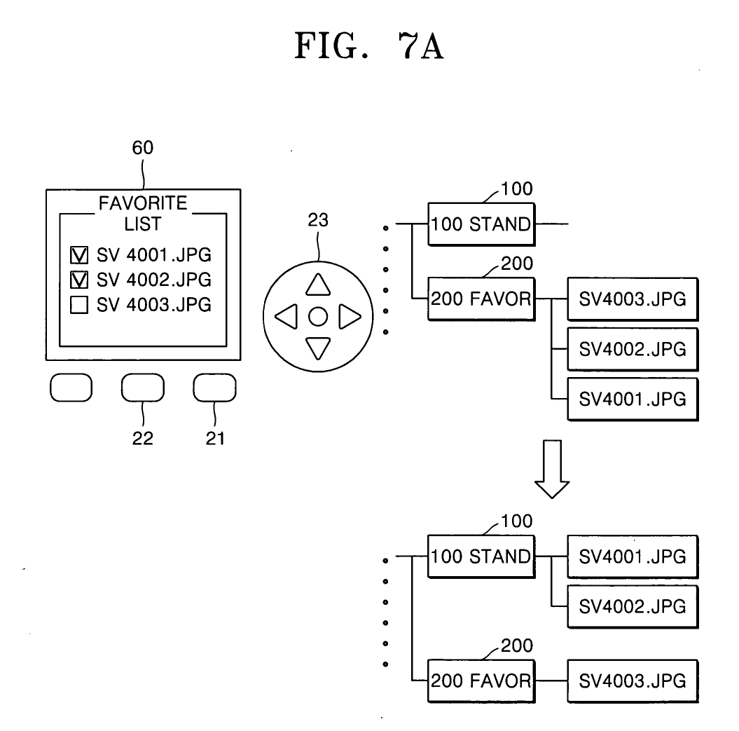

A method for managing the folders of a digital camera according to the present invention will now be explained with reference to FIGS. 8 through 12.

FIG. 8 is a flowchart of an overall embodiment of a folder management method of a digital camera according to the present invention. As shown in step S10 of the flowchart of FIG. 8, in the folder management method according to the present invention, first, the control unit 10 confirms the folder structure of the memory card 50, and then confirms whether or not there is a favorite folder 200 in the memory card 50. If it is determined that there is no favorite folder 200, the control unit 10 generates a favorite folder 200 in the memory card in step S20.

In record mode, when the digital camera lens is directed at an object and the user lightly pushes the release switch half-way to turn on the first switch S1, the control unit 10 will perform auto focus and auto exposure functions. If the user fully pushes the release switch to turn on the second switch S2, the control unit 10 will open the shutter for a predetermined amount of time such that photographed data is generated in the photo devices of the CCD 32. A signal output from the CCD 32 is transmitted to the analog processing unit 34, and correlation double sampling, color separation, and gain adjustment are performed. Then, the signal is converted into a digital signal by the A/D converter 35 and is transmitted to the image processing unit. The image processing unit 30 processes an image signal according to a command provided by the system controller. It includes a luminance and chrominance signal generation circuit, a gamma correction circuit, a contour correction circuit, and a white balance correction circuit. Image data input to the image processing unit 30 is converted into a luminance signal (Y signal) and a chrominance signal (Cr and Cb signals). At the same time, predetermined processing, such as gamma correction, is performed and the data is stored in a DRAM 40. Then, the control unit 10 records the image data stored in the DRAM 40 in the standard folder 100 of the memory card 50 and outputs the image data to the LCD panel 60 such that the user can confirm the image data in step S30.

When necessary, the user can move image data stored in the standard folder 100 to the favorite folder 200 or image data stored in the favorite folder 200 to the standard folder 100 in step S40.

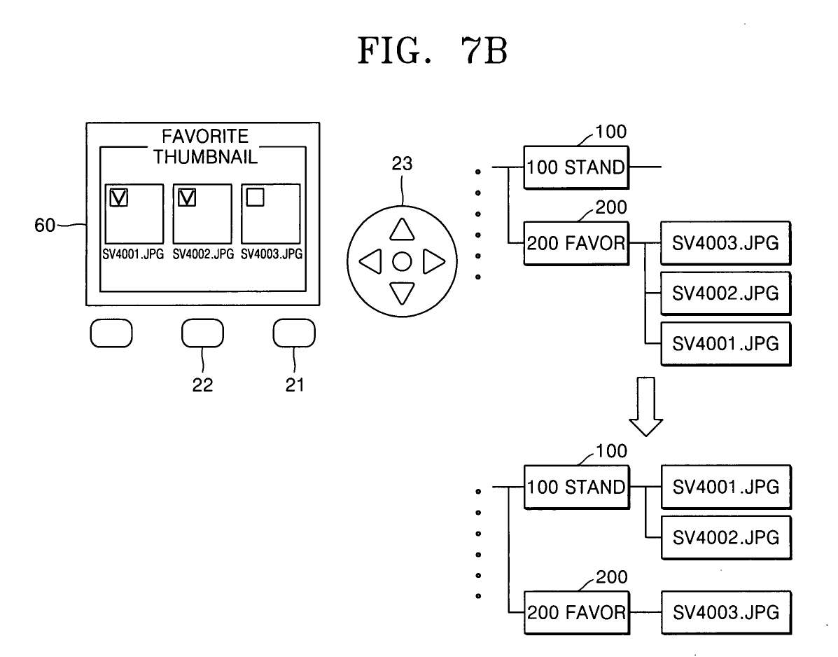

Data movement, in step S40, between the folders will now be explained in more detail with reference to the following embodiments. FIG. 9 is a flowchart of an embodiment to transfer a file contained in a standard folder and displayed on a display unit to a favorite folder, in a folder management method of a digital camera according to the present invention.

As in the previous embodiments, when the user pushes the release switch to shoot an object, image data is generated and the control unit 10 stores the image data in the standard folder 100 in step S30. If the current mode of the digital camera 1 is the record mode, an image taken immediately before is displayed on the display unit 60 for approximately 3˜5 seconds. In step S31, if the current mode of the digital camera 1 is the playback mode, images are displayed on the display unit 60 in the order of time when the image was shot and starting with the most recently photographed image.

If the user selects an image currently displayed on the display unit 60 by pushing the first hotkey 21, the control unit 10 will move the image data from the standard folder 100 to the favorite folder 200. In the actual memory structure, by deleting the start address of the storage location of SV4003.JPG in the file allocation information of the standard folder 100 and adding it to the file allocation information of the favorite folder 200, movement of the file is implemented.

Then, if the digital camera 1 is in the record mode, it returns to a record wait state, and if it is in the playback mode, the latest image excluding the image deleted from the standard folder is displayed in step S51.

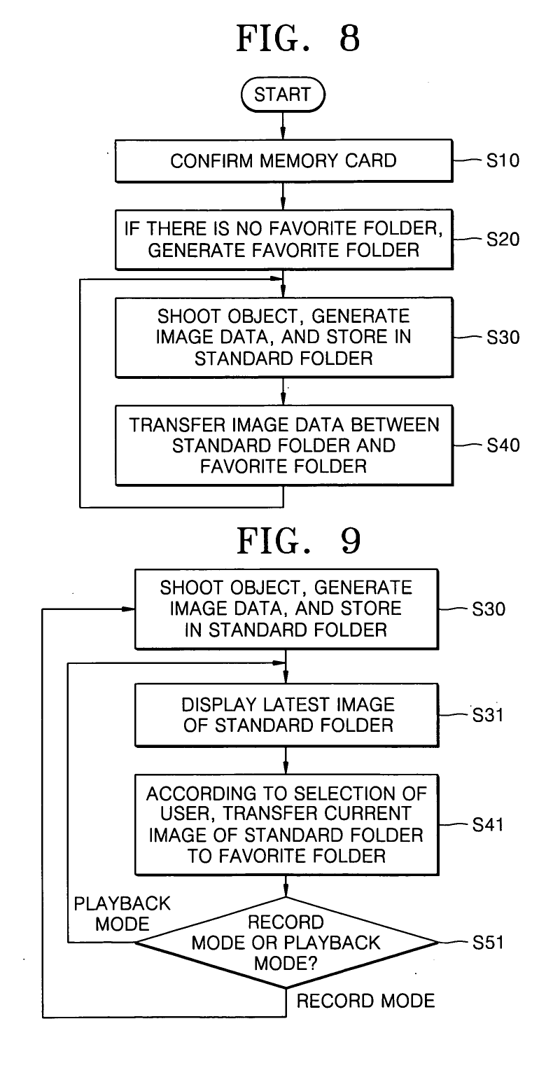

FIG. 10 is a flowchart of an embodiment in a folder management method of a digital camera according to the present invention to transfer files from the list or thumbnail of files contained in a standard folder, and displayed on the display unit, to a favorite folder.

As in the previous embodiment, if the user pushes the release switch to shoot an object and image data is generated, the control unit 10 stores the image data in the standard folder 100 in step S30. Then in step S32, the digital camera 1 displays through the display unit 60 the list or thumbnail of image data in order of shooting times starting with the most recent one. Next, in step S43, if the user selects from the list or thumbnail of image data being displayed currently on the display unit 60 by pushing the first hotkey 21 and the arrow key 23 the control unit 10 moves the data of those images selected from the standard folder 100 to the favorite folder 200. Since the other operations are the same as in the previous embodiment, the explanation will be omitted to avoid redundancy.

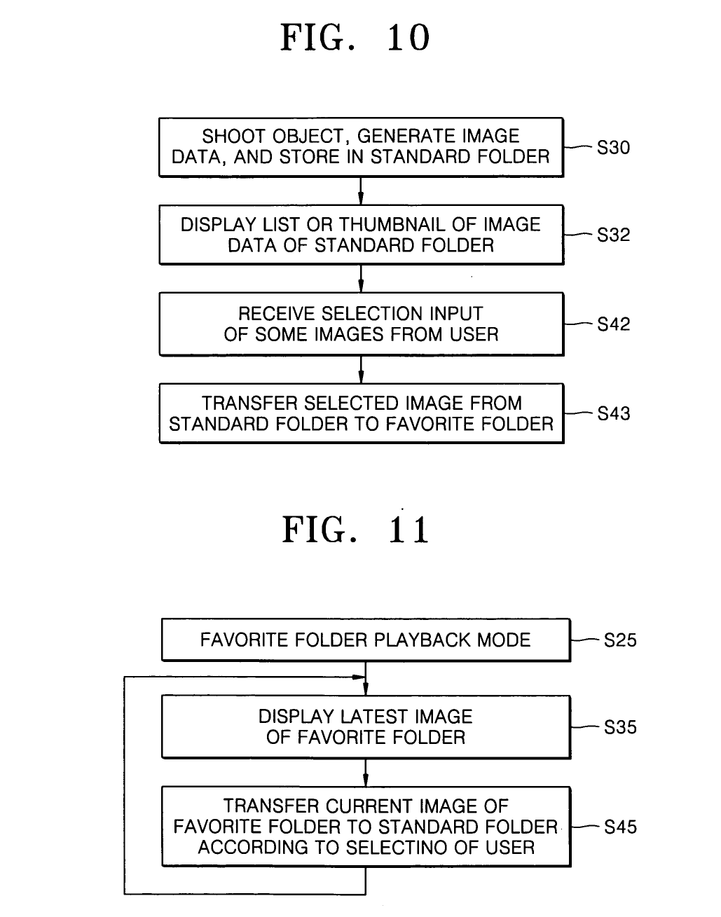

FIG. 11 is a flowchart of an embodiment to transfer a file, displayed on a display unit, from the favorite folder to a standard folder in a folder management method of a digital camera according to the present invention.

If the user commands images previously moved from the standard folder 100 to the favorite folder 200, to be displayed, by pushing the second hotkey 22, the digital camera 1 enters into the playback mode of the favorite folder in step S25, and the latest image of the favorite folder is displayed on the display unit 60 in step S35.

Then, if the user views the image being currently displayed on the display unit 60 and pushes the second hotkey 22, the control unit 10 moves the image data from the standard folder 100 to the favorite folder 200 in step S45.

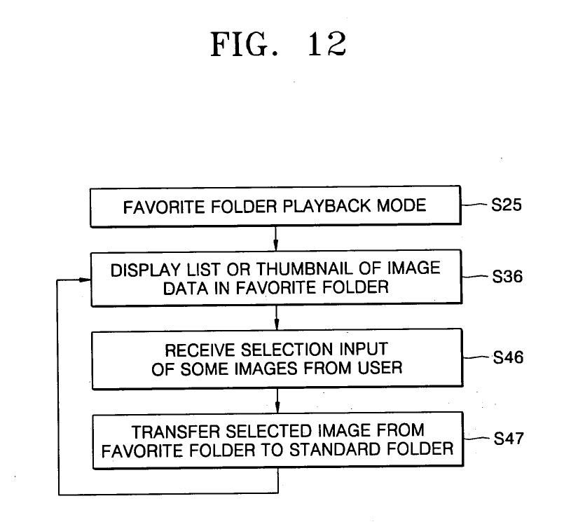

FIG. 12 is a flowchart of an embodiment to transfer from the list or thumbnail of files of a favorite folder displayed on a display unit to a standard folder, in a folder management method of a digital camera according to the present invention.

If the user commands the list or thumbnail of images previously moved from the standard folder 100 to the favorite folder 200 to be displayed, by pushing the second hotkey 22, the digital camera 1 enters into the playback mode of the favorite folder in step S25, and the list or thumbnail of the image data of the favorite folder is displayed on the display unit 60 in step S36.

If the user selects from the list or thumbnail of image data of the favorite folder being displayed on the display unit 60 by pushing the second hotkey 22 and the arrow key 23 in step S46, the control unit 10 moves the data of the selected images from the favorite folder 200 to the standard folder 100 in step S47. When necessary, the step S36 can be performed again to select an image to be moved continuously. Since the other operations are the same as in the previous embodiment, the explanation will be omitted to avoid redundancy.

Meanwhile, in the above embodiments, in order for the user to easily understand that the image data is stored in the favorite folder, data capable of displaying a predetermined mark (for example, ‘\mathring{ƒ}’ mark) on part of an image can be added to the image data stored in the favorite folder, and according to this, the display unit can output the mark to the display data when the image is output (for example, when an image is output, the ‘\mathring{ƒ}’ mark can be output on the top right of the screen). Also, when the image data stored in the favorite folder is moved to the standard folder, the predetermined mark (for example, ‘\mathring{ƒ}’ mark) can be deleted from the image data.

According to the digital camera and the folder management method according to the present invention, in addition to the ordinary standard folder for storing photographed image data, a separate favorite folder capable of storing and reproducing image data with the same format as that of the photographed image data is arranged such that the user can move desired images from the standard folder to the favorite folder when necessary.

Also, according to the digital camera and the folder management method according to the present invention, in the record mode, while a photo taken it is displayed temporarily and the user can move the photo immediately to the favorite folder, and in the playback mode, while photos previously taken are displayed, the user can move the photos immediately to the favorite folder.

Also, in the playback mode, while viewing the list or thumbnail of images stored in the standard folder, the user can select desired images and then move the images at once to the favorite folder. Then, the user can quickly and easily retrieve a desired image by searching the favorite folder, and when necessary, move the image back to the standard folder.

While the present invention has been particularly shown and described with reference to exemplary embodiments thereof, it will be understood by those of ordinary skill in the art that various changes in form and details may be made therein without departing from the spirit and scope of the present invention as defined by the following claims. Such variations and modifications are within the scope of the present invention defined in the appended claims.

1. A digital camera for recording image data of a photographed object and reproducing the recorded image data, comprising:
a memory which includes a standard folder in which the image data for the photographed object is stored, and a favorite folder in which image data is transferred to and stored according to the selection of the user from the images stored in the standard folder;
a display unit which displays the images stored in the folders;
a manipulation unit which is used to select an image from among the image data of photographed objects; and
a control unit which transfers image data of the photographed object between the standard folder and the favorite folder according to the selection of the user, and outputs image data stored in the standard folder or the favorite folder to the display unit.

2. The digital camera of claim 1, wherein the manipulation unit comprises:
a unit which transmits a command to the control unit to move from the standard folder to the favorite folder the image data currently displayed on the display unit among the image data of photographed objects stored in the standard folder.

3. The digital camera of claim 2, wherein the control unit moves from the standard folder to the favorite folder the image data currently displayed on the display unit among the image data of photographed objects stored in the standard folder, and then outputs to the display unit the latest image data, excluding the moved image, from among the image data of photographed objects stored in the standard folder.

4. The digital camera of claim 1, wherein the manipulation unit comprises:
a unit for receiving a selection input from the user for selecting some images of the photographed objects stored in the standard folder; and
a unit for transmitting a command to the control unit for moving the selected image data to the favorite folder.

5. The digital camera of claim 4, wherein the manipulation unit further comprises:
a unit for transmitting a command to the control unit for outputting a list of image data stored in the standard folder to the display unit; and
a unit for receiving a selection input from the user that selects some images from the list of image data.

6. The digital camera of claim 4, wherein the manipulation unit further comprises:
a unit for transmitting a command to the control unit for outputting a thumbnail of image data stored in the standard folder to the display unit; and
a unit for receiving a selection input from the user that selects some of the thumbnail image data.

7. The digital camera of claim 1, wherein the manipulation unit comprises:
a unit which transmits to the control unit a command for moving from the favorite folder to the standard folder image data currently displayed on the display unit from among the image data of the photographed objects stored in the favorite folder.

8. The digital camera of claim 7, wherein the control unit moves from the favorite folder to the standard folder the image data currently displayed on the display unit among the image data of photographed objects stored in the favorite folder, and then outputs to the display unit the latest image data, excluding the moved image data, from among the image data of photographed objects stored in the favorite folder.

9. The digital camera of claim 1, wherein the manipulation unit comprises:
a unit for receiving a selection input from the user for selecting some images of the photographed objects stored in the favorite folder; and
a unit for transmitting a command to the control unit for moving the selected image data to the standard folder.

10. The digital camera of claim 9, wherein the manipulation unit further comprises:
a unit for transmitting a command to the control unit for outputting a list of image data stored in the favorite folder to the display unit; and
a unit for receiving selection input from the user that selects some images from the list of image data.

11. The digital camera of claim 9, wherein the manipulation unit further comprises:
a unit for transmitting a command to the control unit for outputting to the display unit a thumbnail of image data stored in the favorite folder; and
a unit for receiving selection input from the user that selects some of the thumbnail image data.

12. The digital camera of claim 1, wherein when image data is moved from the standard folder to the favorite folder, the control unit adds data to the image display to indicate that the image is stored in the favorite folder, and the display unit outputs the mark to the display when the image is output.

13. A method for managing folders of a digital camera for recording image data of a photographed object and reproducing the recorded image data, the method comprising:
generating a favorite folder capable of storing a file with the same format as that of a file stored in a standard folder;
generating image data by taking a photograph image of an object and storing the image data in the standard folder; and
moving between the standard folder and the favorite folder the generated image data selected by a user.

14. The method of claim 13, further comprising:
displaying the image data of the photographed object stored in the standard folder, and wherein moving the generated image comprises:
moving image data being currently displayed from the standard folder to the favorite folder.

15. The method of claim 14, wherein after the image data currently displayed among the image data of the photographed objects stored in the standard folder is moved from the standard folder to the favorite folder, the latest image, excluding the moved image data, among the image data of the photographed objects stored in the standard folder is output to the display unit and displayed.

16. The method of claim 13, wherein moving the image data comprises:
receiving a selection input from the user for selecting some of the image data of the photographed objects stored in the standard folder; and
moving the selected image data to the favorite folder.

17. The method of claim 16, wherein displaying the image data comprises:
outputting a list of the image data stored in the standard folder to the display unit,
wherein in receiving the selection input from the user for moving the image data, part of the list of the image data is selected by the user.

18. The method of claim 16, wherein displaying the image data comprises:
outputting the thumbnail of the image data stored in the standard folder to the display unit,
wherein in receiving the selection input from the user in moving the image data, part of the thumbnail of the image data is selected by the user.

19. The method of claim 13, further comprising:
displaying the image data stored in the favorite folder,
wherein moving the image data comprises:
moving image data being currently displayed from the favorite folder to the standard folder.

20. The method of claim 19, wherein in displaying the image data, after the image data being currently displayed from among the image data of photographed objects stored in the favorite folder is moved from the favorite folder to the standard folder, the latest image data, excluding the moved image data, from among image data of the photographed objects stored in the favorite folder is output to the display unit.

21. The method of claim 13, wherein moving the image data comprises:
receiving a selection input from the user for selecting some of image data of the photographed objects stored in the favorite folder; and
moving the selected image data to the favorite folder.

22. The method of claim 21, wherein displaying the image data comprises:
outputting the list of the image data stored in the favorite folder to the display unit,
wherein in receiving the selection input from the user for moving the image data, part of the list of the image data is selected by the user.

23. The method of claim 21, wherein displaying the image data comprises:
outputting the thumbnail of the image data stored in the favorite folder to the display unit,
wherein in receiving the selection input from the user for moving the image data, part of the thumbnail of the image data is selected by the user.

24. The method of claim 13, wherein when image data is moved from the standard folder to the favorite folder, a display data mark indicating that the image data is stored in the favorite folder is added to the image data, and the display unit outputs the mark to the display when the image is output.
